(19) United States
(12) Patent Application Publication
(10) Pub. No.: US 2025/0217272 A1
(43) Pub. Date: Jul. 3, 2025

(54) MULTIPATHING CODE FOR ENHANCED RESILIENCE

(71) Applicant: International Business Machines Corporation, Armonk, NY (US)

(72) Inventors: Andrew C. M. Hicks, Highland, NY (US); Desmond Fitzpatrick, OSSINING, NY (US); John S. Werner, Fishkill, NY (US)

(21) Appl. No.: 18/402,809

(22) Filed: Jan. 3, 2024

(51) Int. Cl. G06F 11/36

(52) U.S. Cl. CPC G06F 11/3698

(57) ABSTRACT

A computer-implemented method provides rewinding and switching to a new code-path after an error in a preferred code-path. The method includes identifying a first error during execution of an application. The method further includes determining, in response to the first error, a previous breakpoint in a first code-path of the application prior to the location of the first error. The method also includes rewinding the application from the first error to the previous breakpoint. The method includes initiating, in response to the rewinding, a second code-path available at the previous breakpoint. Further aspects of the present disclosure are directed to systems and computer program products containing functionality consistent with the method described above.

### BACKGROUND

The present disclosure relates to resilience of computing systems, and, more specifically, to increasing resilience for critical programs with multipathing code.

Maintaining resilience and availability of computing systems can be a difficult challenge. Minor errors can cause issues and/or shutdowns of computing systems.

### SUMMARY

Disclosed is a computer-implemented method to provide rewinding and switching to a new code-path after an error in a preferred code-path. The method includes identifying a first error during execution of an application. The method further includes determining, in response to the first error, a previous breakpoint in a first code-path of the application prior to the location of the first error. The method also includes rewinding the application from the first error to the previous breakpoint. The method includes initiating, in response to the rewinding, a second code-path available at the previous breakpoint. Further aspects of the present disclosure are directed to systems and computer program products containing functionality consistent with the method described above.

The present Summary is not intended to illustrate each aspect of, every implementation of, and/or every embodiment of the present disclosure.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1 is a block diagram of a computing environment suitable for generating and updating a display in a vehicle, in accordance with some embodiments of the present disclosure.

FIG. 2 is a block diagram of a computing environment suitable for operation of a multipathing manager in accordance with some embodiments of the present disclosure.

FIG. 3 is a flow chart of an example method to generate a code-path map, in accordance with some embodiments of the present disclosure.

FIG. 4 is a flow chart of an example method to dynamically switch between code-paths based on an error in one code-path, in accordance with some embodiments of the present disclosure.

FIG. 5 is one illustrative embodiment of a code-path code map, in accordance with some embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamically altering a code-path after errors in critical systems 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

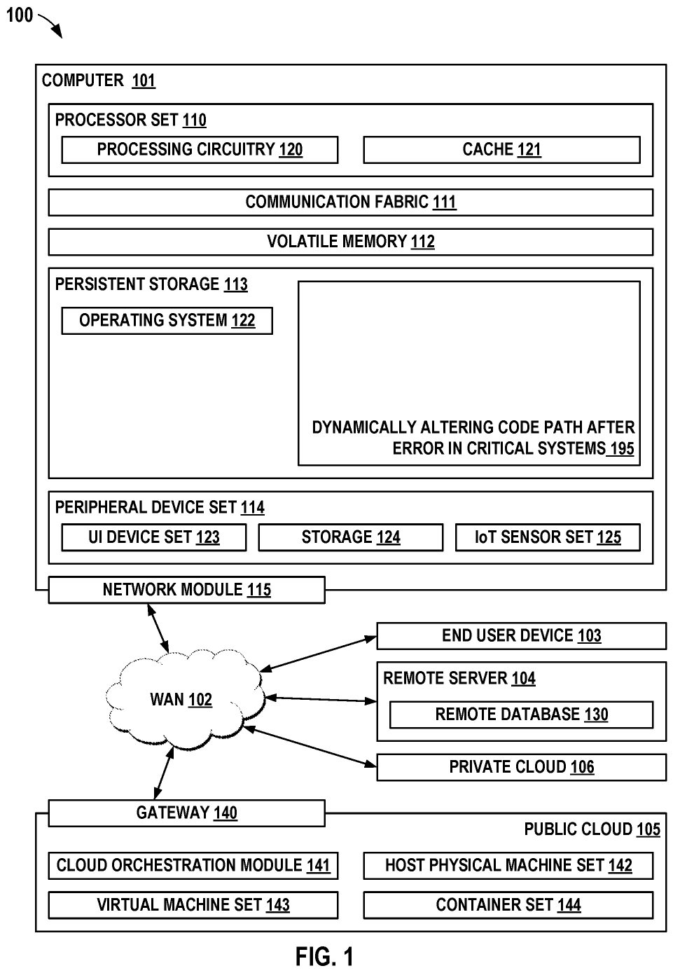

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Maintaining resilience and availability of computing systems can be a difficult challenge. Minor errors can cause issues and/or shutdowns of computing systems. Various error detection and management techniques exists to identify locations and/or causes of various errors in a computing system.

Maintaining resilience and availability of computing systems can be a difficult challenge. Unknown or unexpected errors can cause issues and/or shutdown of computing systems. There are various error detection and management techniques to identify locations and/or causes of various errors in a computing system. However, particularly on a critical process, a minor error can have an outsized effect on the process. Failures and/or system downtime, even if only lasting for short durations (e.g., minutes) can lead to millions of dollars in revenue loss. In some cases, a human must review the error output, then proceed to fix and reboot/reload any system. Additionally, in some computing systems, conventional error management methodologies are inadequate against recurring errors. The ability to prevent, identify, and remedy errors in systems can be a great value.

At times, the potential for errors can limit the ability to upgrade and/or change existing systems. When a minor error can cause the shutdown of a critical system, extensive testing, for essentially all scenarios, needs to be performed prior to pushing any upgrades. This can lead to various potential issues, such as information security, and other similar issues.

Embodiments of the present disclosure include a multipathing manager (or multi-path code manager). In some embodiments, the multipathing manager can dynamically alter a code-path in response to an identified error. This allows for the system to continue to operate despite the error condition, while allowing for time to remedy the now identified error. The dynamic switching between code-paths that perform the same or similar function, or said differently, the switching between code-paths, can lead to a common/consistent output.

In some embodiments, the multipathing manager identifies strategic breakpoints (or checkpoints) in a code-path for one or more applications. The breakpoints can have two or more different code-paths to perform a defined set of operations. When an error is identified in the first code-path, the multipathing manager can back out of the path with the error and execute one of the alternate code-paths. The code-paths can include modules of code, routing to a specific piece of hardware/processor, and the like. The multipathing manager allows for earlier deployment of updated systems and/or in-process testing. A system can be deployed without a reduced risk of outage based on an error. If that error occurs, the previously executed path that is known to work is still available. In the event of an error in the newly deployed code/hardware, the multipathing manager can dynamically re-route the processing to the older/alternate code-path. This can provide for error checking in a production environment.

In some embodiments, the multipathing manager includes a code-path complexity analysis (or complexity analysis). This analysis ensures the distinctiveness of each code-path. This can provide an alternate path for some portions of code for execution at all times that is unlikely to experience the same error as the primary path or the path that was selected to execute first. It can be a redundancy built into the system/application architecture. In some embodiments, the multipathing manager identifies a preferred code-path. The preferred code-path is the path that will be executed first, and alternate paths will only be executed if an error occurs in the preferred code-path.

In some embodiments, the multipathing manager gathers a set of data at each breakpoint and/or in between each breakpoint. The set of data can be a status of the application, the operating system (OS), currently running processes, inputs to certain functions, and other relevant data. The set of data can be configured to allow the multipathing manager to back out of a code-path after an error is identified. The set of data (or the set of rewind data) can be used to proceed down an alternate code-path such that a new error does not cause an error, or an outage/shutdown of the overall system and production can continue as the errors are bypassed. In some embodiments, the multipathing manager can update the preferred code-path such that the errored segment is no longer used, and the segment of code that did not cause any errors is selected on future iterations.

The aforementioned advantages are example advantages, and embodiments exist that can contain all, some, or none of the aforementioned advantages while remaining within the spirit and scope of the present disclosure.

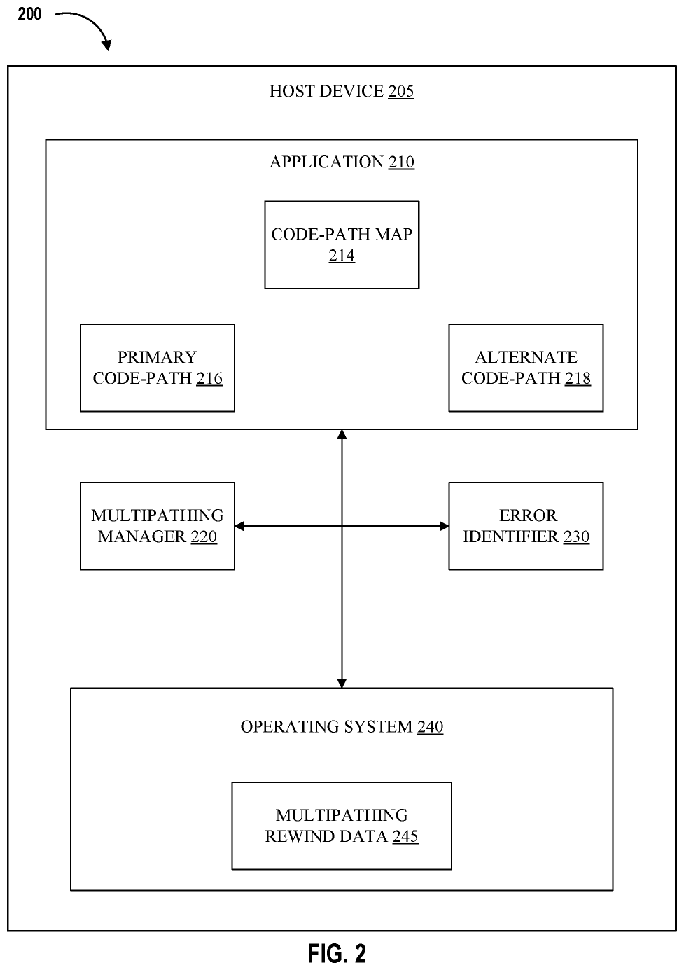

Referring now to various embodiments of the disclosure in more detail, FIG. 2 is a representation of a computing environment 200 that is capable of running a multipathing manager (e.g., multipathing manager 220) in accordance with one or more embodiments of the present disclosure. Many modifications to the depicted environment may be made by those skilled in the art without departing from the scope of the disclosure.

In some embodiments, computing environment 200 includes host device 205.

Host device 205 can be a standalone computing device, a management server, a web server, a mobile computing device, or any other electronic device or computing system capable of receiving, sending, and processing data. In other embodiments, host device 205 can represent a server computing system utilizing multiple computers as a server system, such as in a cloud computing environment (e.g., cloud environment 105 or 106). In some embodiments, host device 205 includes application 210, multipathing manager 220, error identifier 230, and operating system 240. In some embodiments, host device 205 and other devices, not shown, may include one or more computer systems, such as computer 101 of FIG. 1.

Application 210 can be any combination of hardware and/or software configured to carry out one or more tasks/functions on a computing device (e.g., host device 205). In some embodiments, application 210 represents two or more individual software applications running simultaneously. In some embodiments, application 210 sends system instructions to operating system 240, error identifier 230, and/or multipathing manager 220 and receives the processed results from operating system 240, error identifier 230, and/or multipathing manager 220. In some embodiments, application 210 is a set of instructions configured to perform one or more tasks. In some embodiments, application 210 is a software program (e.g., accounting software, system backup software, word processor, etc.). In some embodiments, application 210 includes code-path map 214, primary code-path 216, and alternate code-path 218. In some embodiments, application 210 and/or alternate code-path 218 include one or more additional code-paths that are not shown. Primary code-path 216, alternate code-path 218, and the one or more additional code-paths can represent the code paths at each breakpoint. In some embodiments, primary code-path 216, alternate code-path 218, and the one or more additional code-paths are included in code-path map 214.

Code-path map 214 can be any combination of hardware and/or software configured to identify the various code-paths in application 210. In some embodiments, code-path map 214 indicates one or more breakpoints in application 210 with the two or more code-paths after each breakpoint. Each individual code-path can be referred to as a segment or code segment. A breakpoint (or checkpoint, or fork) is any point in application 210 that has two or more distinct code-paths (or segments) configured to perform a similar task and/or subtask of application 210.

In some embodiments, code-path map 214 includes a preferred path at each breakpoint. The preferred path (or primary path, or default path) is a path that multipathing manager 220 is configured to perform first. The preferred path can be previously defined, manually entered, randomly selected, and/or selected based on predetermined criteria. In some embodiments, the criteria can be based on anticipated execution cost, predicted execution time, age of code, version of code, length of code, and the like. For example, the newest version of code for a particular path/branch can be the preferred path. In another example, the path with a lowest predicted execution time can be the preferred path. In some embodiments, the preferred path is based on analysis of the code by multipathing manager 220.

In some embodiments, the breakpoints in code-path map 214 are based on critical portions/tasks of application 210. In some embodiments, critical functions are predetermined and/or predefined in application 210. In some embodiments, the critical function can be based on identifying one or more errors in previous executions. For example, if a portion of code exceeds an error count, it can be considered a critical function/critical portion of the code. In some embodiments, code-path map 214 ensures that each critical section of code in application 210 include at least two distinct code-paths to perform the critical function. The two distinct code-paths can diverge at the breakpoints.

In some embodiments, code-path map 214 includes instructions on a set of data that can be used to mark each breakpoint. The set of data can be used to mark breakpoints as a starting point for an alternate code-path.

Primary code-path 216 can be any code/instructions to perform a task/subtask one or more applications 210. In some embodiments, primary code-path 216 is one code-path of two or more potential code-paths for a portion of application 210. In some embodiments, primary code-path 216 is the preferred/default code-path. In some embodiments, primary code-path 216 is newly updated/deployed code.

Alternate code-path 218 can be an alternate code-path to primary code-path 216. In some embodiments, each alternate code-path 218 includes two or more distinct code-paths. Alternate code-path 218 can be configured to perform the same function/task as the primary code 216 but is completely independent. In some embodiments, alternate code-path 218 start at the same breakpoint as primary code-path 216. In some embodiments, alternate code-path 218 and primary code-path 216 perform a critical task. In some embodiments, alternate code-path 218 can be newly generated code. The newly generated code can be tested less than primary code-path 216 and/or less than when typically deployed. In some embodiments, alternate code-path 218 can be fully tested alternative method to perform the relevant task. Alternate code-paths 218 can be in place to act as a redundant path to prevent system errors, failures, and outages in the event that primary code-path 216 fails.

Multipathing manager 220 can be any combination of hardware and/or software configured to allow for dynamic switching between multiple code-path segments. In some embodiments, multipathing manager 220 can dynamically switch between two or more code-paths at a breakpoint. In some embodiments, multipathing manager 220 executes two code-paths simultaneously. For example, primary code-path 216 and alternate code-path 218 can both be executed at the same time, and the path with no errors chosen as the output. In some embodiments, the switch is in response to an error in one of the code-path segments. In some embodiments, the code-paths are software code-paths. In some embodiments, the code-path is a hardware path. For example, the path can be a particular server, a particular circuit/card, a particular processor, and the like.

In some embodiments, multipathing manager 220 defines a preferred code-path for each breakpoint and/or critical portion of application 210. Defining/selecting the preferred code-path can be based on an analysis of the various paths. The analysis can be determined to identify various performance characteristics of all potential code-paths. The performance characteristics can include time to execute, power to execute, required storage, required memory, length of code, number and/or location of errors, and the like. In some embodiments, the preferred path can be based on operating conditions. The operating conditions can include available computing resources, any parallel processes, time of day, priority of processes, and the like.

In some embodiments, multipathing manager 220 stores a set of data at the start of each breakpoint. The set to data can be rewind data 245. The rewind data 245 is configured to allow the process to restart at the breakpoint down any of the potential code-paths associated with that breakpoint. The restart can be as if the new code-path was initiated on the initial pass, rather than after an error in the other code-path. In some embodiments, the set of data is updated as the code progresses through the code-path to the next breakpoint. In some embodiments, the set of data allows for multipathing manager 220 to back out of the code-path (or rewind). The backing out allows application 210 to continue to operate if an issue occurs in the executed code-path. The set of data can be sent to application 210 and/or operating system 240. Multipathing rewind data 245 can be stored through several breakpoints. This allows multipathing manager 220 to rewind through multiple breakpoints if all code-paths after a specific breakpoint are determined to have errors.

In some embodiments, multipathing manager 220 updates a preferred code-path. The update is based on identifying an error in the previously selected preferred code-path. In some embodiments, the update is based on an error count. For example, if an error count exceeds a threshold for a particular path, that path is downgraded to an alternate path and one of the one or more alternate paths are promoted as the preferred/primary path. In another example, a path with the lowest error count can be marked as the preferred path.

Error identifier 230 can be any combination of hardware and/or software configured to identify and record errors on application 210 running on host device 205. In some embodiments, error identifier 230 coordinates with application 210, multipathing manager 220, and operation system 240. In some embodiments, error identifier 230 can be any process to identify and track errors in application 210, multipathing manager 220, and/or operating system 240. In some embodiments, error identifier 230 is incorporated into one or more of application 210, multipathing manager 220, and operating system 240.

In some embodiments, error identifier 230 keeps an error count. The error count can be tied to a specific code-path and include an error type. In some embodiments, the specific code-path can be between two breakpoints. The location allows for backtracking to a point in the executed code-path before an error occurred. This can be for the process as a whole, one iteration, or a particular one or the one or more segments.

Operating system 240 can be any combination of hardware and software capable of managing the workload of host device 205 and provide access to low-level operating components of the host device 205. In some embodiments, operating system 240 is consistent with operating system 122 of FIG. 1. In some embodiments, operating system 240 receives system calls from application 210 requesting resources of host device 205. Operating system 240 prioritizes and executes the system calls based on one or more algorithms. In some embodiments, operating system 240 includes and multipathing rewind data 245. For purposes of this application, the term kernel and operating system can be interchangeable. In some embodiments, operating system 240 can be communicatively coupled to the other components of host device 205. In some embodiments, operation system 240 can execute instructions provided by application 210 while interfacing with multipathing manager 220 and/or error identifier 230. In some embodiments, operation system 240 includes multipathing rewind data 245.

Multipathing rewind data 245 can be a set of data used to rewind the operating system to a predefined condition. In some embodiments, multipathing rewind data 245 includes rewind data as obtained by multipathing manager 220. In some embodiments, the set of data can be updated and/or added to at various times based on code-path map 214. The set of data is configured to rewind/reset the operating system 240 and/or application 210 to the conditions at the critical points (e.g., breakpoints, forks, etc.). In some embodiments, multipathing rewind data 245 can include one or more sets of data. A set of data can be stored each time the code passes a breakpoint/fork. In some embodiments, the set of data can be determined by multipathing manager 220. In some embodiments, each set of data includes a set of inputs and status for critical data. In some embodiments, the set of data can include data as code progresses down one path of the multiple paths.

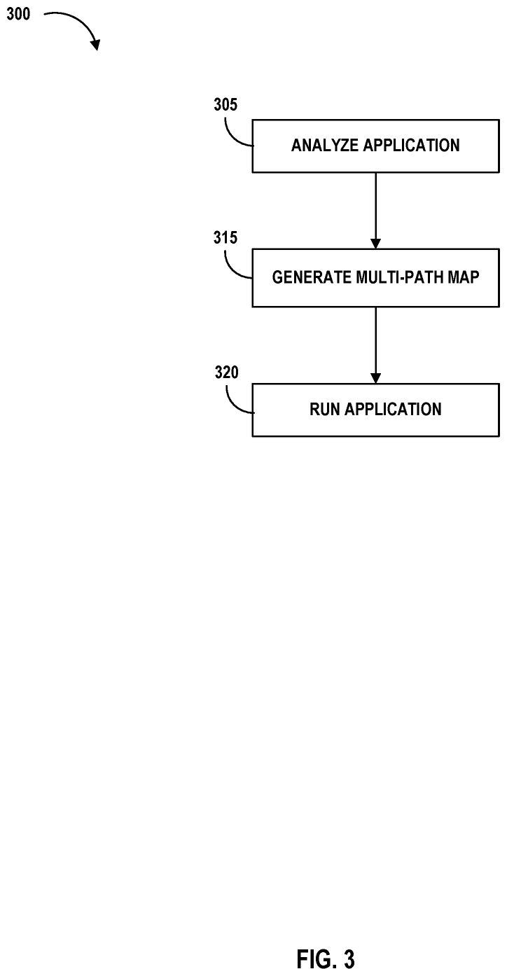

FIG. 3 is a flowchart of an example process 300 for generating a code-path map (e.g., code-path map 214) in an application performed in a computing environment (e.g., computing environment 100 and/or computing environment 200). One or more of the advantages and improvements described above for utilizing multi-pathing code may be realized by process 300, consistent with various embodiments of the present disclosure.

Process 300 can be implemented by one or more processors, host device 205, application 210, multipathing manager 220, error identifier 230, operation system 240, and/or a different combination of hardware and/or software. In various embodiments, the various operations of process 300 are performed by one or more host device 205, application 210, multipathing manager 220, error identifier 230, and operation system 240. For illustrative purposes, the process 300 will be described as being performed by multipathing manager 220.

At operation 305, multipathing manager 220 analyzes application 210. In some embodiments, operation 305 includes identifying critical functions of application 210. In some embodiments, the analysis includes identifying each breakpoint in application 210. In some embodiments, each breakpoint in application 210 can be a point where the state of the system can be easily saved such that rewinding to take an alternate code-path is possible. In some embodiments, the breakpoints are correlated with critical functions. For example, each critical function/portion can be correlated to one or more breakpoints. Each breakpoint can have at least two distinct code-paths. Each code-path can be configured to produce an outcome that will lead to the same overall outcome desired by application 210. In some embodiments, the analysis predicts performance characteristic of each code-path.

At operation 315, multipathing manager 220 generates code-path map 214. In some embodiments, the generating includes defining preferred code-paths at each breakpoint. In some embodiments, operation 315 includes ensuring at least two code-paths for each critical function.

At operation 320, multipathing manager 220 runs application 210. In some embodiments, application 210 is running prior to operations 305-315. The running application can provide the basis for completing the previous operations. In some embodiments, having application 210 operating is a prerequisite to method 400 below.

In some embodiments, operation 320 includes storing the set of rewind data for each breakpoint. The set of data can be stored as multipathing rewind data 245.

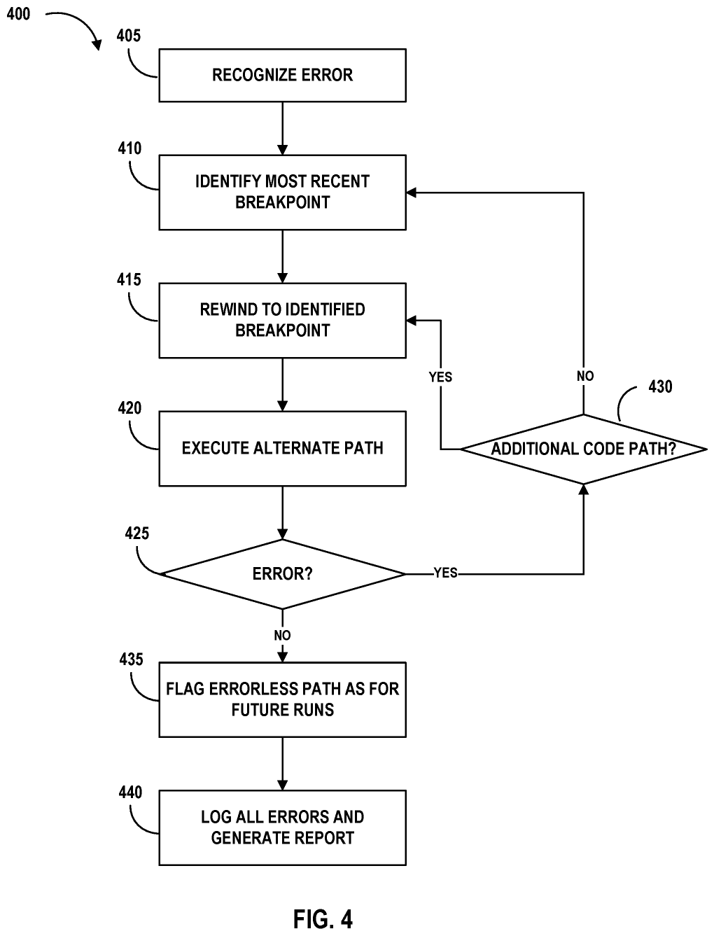

FIG. 4 is a flowchart of an example process 400 for dynamically switching between code-paths based on errors in an application performed in a computing environment (e.g., computing environment 100 and/or computing environment 200). One or more of the advantages and improvements described above for utilizing multi-pathing code may be realized by process 400, consistent with various embodiments of the present disclosure.

Process 400 can be implemented by one or more processors, host device 205, application 210, multipathing manager 220, error identifier 230, operation system 240, and/or a different combination of hardware and/or software. In various embodiments, the various operations of process 400 are performed by one or more host device 205, application 210, multipathing manager 220, error identifier 230, and operation system 240. For illustrative purposes, the process 400 will be described as being performed by multipathing manager 220.

At operation 405, multipathing manager 220 recognizes an error. In some embodiments, error identifier 230 determines the error and sends the error data to multipathing manager 220. In some embodiments, the error can be any type of error. In some embodiments, the error prevents multipathing manager 220 from progressing down the identified code-path.

In some embodiments, method 400 occurs in response to operations 305-315 of method 300. This includes having each breakpoint mapped, each potential code-path, and a predetermined path to take at each breakpoint/fork.

At operation 410, multipathing manager 220 identifies a most recent breakpoint. In some embodiments, the most recent breakpoint is the breakpoint most recently executed. In some embodiments, the most recent breakpoint is the breakpoint that has been passed during execution that has an alternate code-path. In some embodiments, the method may attempt to go further back than the most recent breakpoint within the code-path if the rewind data exists (e.g., go back two or three breakpoints). In some embodiments, the most recent breakpoint is a breakpoint that has a set of rewind data that has been stored and is associated with the breakpoint. If no previous breakpoint exits, then the error is handled using standard error handling procedures.

At operation 415, multipathing manager 220 rewinds to the identified breakpoint. In some embodiments, the rewinding includes restoring the system inputs as they were when the breakpoints were passed in the code-path. In some embodiments, multipathing rewind data 245 is used to rewind to the breakpoint. After rewinding, application 210 will be as if it did not proceed down the previously executed code-path (e.g., primary code-path 216 and/or one of the one or more alternate code-paths 218).

At operation 420, multipathing manager 220 executes an alternate code-path 218. In some embodiments, the alternate code-path can be any code-path that has not been previously executed. The alternate code-path can be based on the analysis of method 300. For example, the code-path with a particular attribute (e.g., lowest cost) that has not been executed can be selected.

At operation 425, multipathing manager 220 monitors for errors. In some embodiments, the monitoring is performed by error identifier 230. If no error is identified (425: NO), the multipathing manager 220 proceeds to operation 435. If an error is identified (425: YES), then multipathing manager 220 proceeds to operation 430.

At operation 430, multipathing manager 220 determines if there are additional code-paths from the breakpoint that have not been attempted. In some embodiments, if any code-path for the breakpoint does not have an error that has been identified during execution, then there is an additional code-path. If all the code-paths have been executed and have errors, then there is no additional code-path. If additional code-paths are identified (430: YES), then multipathing manager 220 return to operation 415. If no additional code-paths are identified (430: NO), then multipathing manager 220 returns to operation 410. In some embodiments, multipathing manager 220 can return to a next (or any number) most recent breakpoint for which rewind data is stored. If there are no breakpoints with the necessary rewind data, then multipathing manager 220 and/or error identifier 230 can generate an error ticket/notification. The error ticket can be sent to developers using standard notification processes.

At operation 435, multipathing manager 220 flags the errorless code-path. In some embodiments, the errorless code-path includes any executed code between any two breakpoints with no errors. In some embodiments, operation 435 includes updating the preferred path to the errorless code-path. Updating the preferred path can include updating code-path map 214.

At operation 440, multipathing manager 220 generates an overall error log. In some embodiments, the overall error log includes each instance of error, known conditions surrounding the error, location in the code-path, which code-path, location relative to one or more breakpoints, and the like. The error log can be used in further analysis of application 210. Understanding where the error occurs can lead to fixing of errors. Additionally, the understanding can prompt an update to preferred code-paths. In some embodiments, operation 440 includes auto-generation of an error ticket or other notification. The error ticket can be sent to the developers using standard error processing techniques. The notification can include any errors identified for any code-path during execution of application 210.

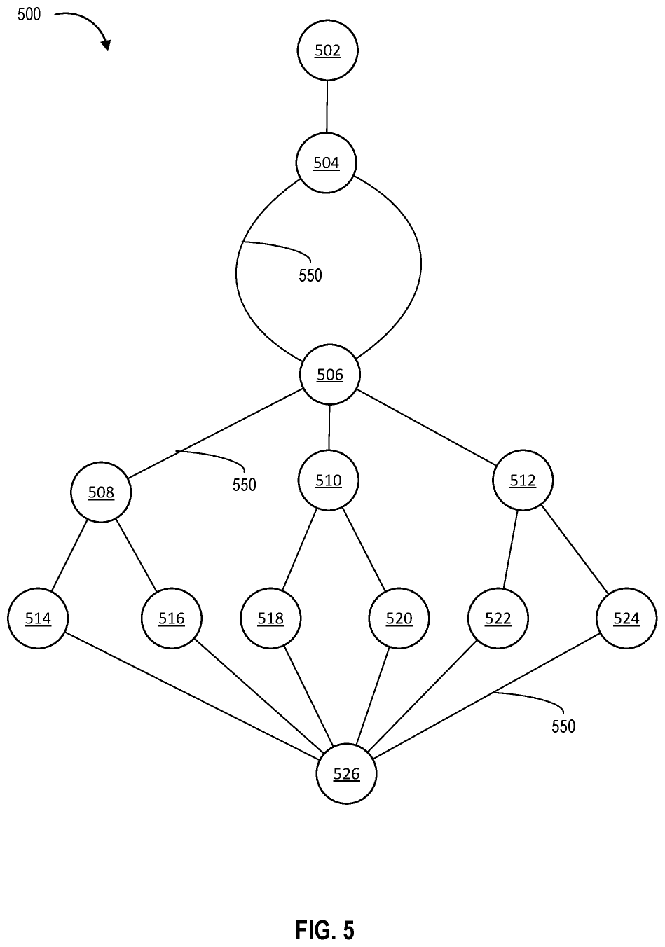

FIG. 5 is one embodiment of a code-path map or a portion of a path-map for application 210. FIG. 5 includes code-path map 500. In some embodiments, code-path map 500 can be consistent with code-path map 214 of FIG. 2. Code-path map 500 comprises a starting point 502, a plurality of breakpoints 504, 506, 508, 510, 512, 514, 516, 518, 520, 522, 524, and 526. In some embodiments, 514, 516, 518, 520, 522, 524, and 526 can be endpoints and/or breakpoints with additional code segments (not shown) available. In some embodiments, application 210 includes loops and/or other processing actions not shown.

FIG. 5 further includes a plurality of code-path segments 550. Each line between two different breakpoints or starting points represents one code-path. In some embodiments, two different code-paths from one breakpoint can end at a common breakpoint. This is shown between breakpoints 504 and 506. In some embodiments, each code segment can end at a different breakpoint as shown by breakpoints 506, 508, 510, and 512.

To illustrate the methods 300 and 400, consider the following embodiments. Application 210 analyses this portion of application 210 and generates code-path map 500. A preferred path can be the rightmost option from 502 to 504 to 506 to 512, and finally to 524. If an error is identified between 504 and 506, multipathing manager 220 can rewind to 504 and proceed down the alternate code-path to 506. If, for example, the first code-path was a new piece of code that went through preliminary testing but not a full suite of testing, the error could be identified, but the process does not need to be stopped. The method can rewind to 504 and take the old code-path which may be a slower execution time, but has proven to execute well in production with no error, and the alternate code-path (i.e., old code-path in this example) is updated as the preferred code-path. Continuing, if multipathing manager 220 identifies an error between 512 and 524, it will rewind to 512 and attempt the code-path to 522. If another error is identified leading to 522, multipathing manager 220 will rewind to 512, determine no additional code-paths without an error are available, then further rewind to breakpoint 506. Multipathing manager 220 will then execute the 506 to 508 code-path or the 506 to 510 code-path based on the results of the analysis and the various settings with the ultimate goal of finding a code-path from 502 to 526 that contains no errors.

Embodiments of the present disclosure can dynamically alter code-paths to complete a process without having to stop the process and result in an error without completing a task and/or returning a result. This can provide built in resilience for critical systems. Additionally, it can provide for faster deployment of updates knowing the previous code can be run when or if issues are found in the updated code.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In summary, various embodiments have been discussed which are again specified in the following numbered examples:
Example 1 is as follows. A computer-implemented method comprising, identifying a first error during execution of an application; determining, in response to the first error, a previous breakpoint in a first code-path of the application prior to the location of the first error; rewinding the application from the first error to the previous breakpoint; and initiating, in response to the rewinding, a second code-path available at the previous breakpoint. This provides a built-in redundant code system that allows for continued operation when an error occurs in a preferred code-path.
Example 2 is as follows. The method of example 1, further comprising: analyzing the application; and generating, in response to the analysis, a code-path map, where the identifying the first error is in response to the generating the code-path map. This demonstrates the code-paths are known prior to the execution of the code.
Example 3 is as follows. The method of any of the preceding examples, where each breakpoint is associated with a critical portion of the application. This provides for the redundancy at critical points in the application.
Example 4 is as follows. The method of any of the preceding examples, where the code-path map comprises one or more breakpoints, each breakpoint comprises two or more distinct code-paths configured to obtain a common result. This provides for the two or more code-paths and a starting point for to continue operation in response to an error.
Example 5 is as follows. The method of any of the preceding examples further comprising: identifying, on the second code-path, a second error; rewinding the application to the most recent code-path; and initiating, in response to the rewinding, a third code-path available at the most recent breakpoint. This provides further redundancy to rewind behind all potential errors in a code-path.
Example 6 is as follows. The method of any of the preceding examples further comprising: processing the second code-path with no errors; flagging the second code-path as error-free; and updating the code-path map to indicate the second code-path as a preferred code-path. This provides for automatically updating a preferred execution path the code-path with no identified errors.
Example 7 is as follows. The method of any of the preceding examples further comprising: recording, at each breakpoint, a set of rewind data, where the rewind data captures a state of the application prior to proceeding down a relevant code-path, wherein the set of rewind data is configured to allow the rewinding. This provides the inputs and data necessary to proceed down an alternate code-path.
Example 8 is as follows. The method of any of the preceding examples further comprising: determining, in response to the rewinding, all code-paths associated with the breakpoint have an identified error; and rewinding to a next most recent breakpoint. This provides further redundancy to rewind behind all potential errors in a code-path.
Example 9 is as follows. The method of any of the preceding examples, where the first code-path is newly deployed code, and the second code-path is previously used code. This provides a method to implement new code and/or implement two different code-paths for a particular function of the application.
Example 10 is as follows. The method of any of the preceding examples, further comprising: logging the first error; and generating an error report comprising the first error report and any additional identified errors. This allows for the logging of all errors on the code-paths so they can be identified and fixed.
Example 11 is as follows. A system comprising: a processor; and a computer-readable storage medium communicatively coupled to the processor and storing program instructions which, when executed by the processor, are configured to cause the processor to: identify a first error during execution of an application; determine, in response to the first error, a previous breakpoint in a first code-path of the application prior to the location of the first error; rewind the application from the first error to the previous breakpoint; and initiate, in response to the rewinding, a second code-path available at the previous breakpoint. This provides a built-in redundant code system that allows for continued operation when an error occurs in preferred code-path.
Example 12 is as follows. The system of example 11, wherein the program instructions are further configured to cause the processor to: analyze the application; and generate, in response to the analysis, a code-path map, where the identifying the first error is in response to the generating the code-path map. This demonstrates the code-paths are known prior to the execution of the code.
Example 13 is as follows. The system of any of the examples 11 and 12, where each breakpoint is associated with a critical portion of the application. This provides for the redundancy at critical points in the application.
Example 14 is as follows. The system of any of the examples 11 through 13, where the code-path map comprises one or more breakpoints, each breakpoint comprises two or more distinct code-paths configured to obtain a common result. This provides for the two or more code-paths and a starting point for to continue operation in response to an error.
Example 15 is as follows. The system of any of the examples 11 through 14, where the program instructions are further configured to cause the processor to: processing the second code-path with no errors; flagging the second code-path as error-free; and updating the code-path map to indicate the second code-path as a preferred code-path. This provides for automatically updating the preferred execution path the code-path with no identified errors.
Example 16 is as follows. A computer program product, the computer program product comprising a computer readable storage medium having program instructions embodied therewith, the program instructions executable by a processing unit to cause the processing unit to: identify a first error during execution of an application; determine, in response to the first error, a previous breakpoint in a first code-path of the application prior to the location of the first error; rewind the application from the first error to the previous breakpoint; and initiate, in response to the rewinding, a second code-path available at the previous breakpoint. This provides a built-in redundant code system that allows for continued operation when an error occurs in preferred code-path.
Example 17 is as follows. The computer program product of example 16, wherein the program instructions are further configured to cause the processing unit to: analyze the application; and generate, in response to the analysis, a code-path map, where the identifying the first error is in response to the generating the code-path map. This demonstrates the code-paths are known prior to the execution of the code.
Example 18 is as follows. The computer program product of any of the examples 16 and 17, where each breakpoint is associated with a critical portion of the application. This provides for the redundancy at critical points in the application.
Example 19 is as follows. The computer program product of any of the examples 16 through 18, where the code-path map comprises one or more breakpoints, each breakpoint comprises two or more distinct code-paths configured to obtain a common result. This provides for the two or more code-paths and a starting point for to continue operation in response to an error.
Example 20 is as follows. The computer program product of any of the examples 16 through 19, where the program instructions are further configured to cause the processing unit to: processing the second code-path with no errors; flagging the second code-path as error-free; and updating the code-path map to indicate the second code-path as a preferred code-path. This provides for automatically updating the preferred execution path the code-path with no identified errors.

What is claimed is:

1. A computer-implemented method comprising:
identifying a first error during execution of an application;
determining, in response to the first error, a previous breakpoint in a first code-path of the application prior to the location of the first error;
rewinding the application from the first error to the previous breakpoint; and
initiating, in response to the rewinding, a second code-path available at the previous breakpoint.

2. The computer-implemented method of claim 1, further comprising:
analyzing the application; and
generating, in response to the analysis, a code-path map, wherein the identifying the first error is in response to the generating the code-path map.

3. The computer-implemented method of claim 2, wherein each breakpoint is associated with a critical portion of the application.

4. The computer-implemented method of claim 2, wherein the code-path map comprises one or more breakpoints, each breakpoint comprises two or more distinct code-paths configured to obtain a common result.

5. The computer-implemented method of claim 4, further comprising:
identifying, on the second code-path, a second error;
rewinding the application to the most recent code-path; and
initiating, in response to the rewinding, a third code-path available at the most recent breakpoint.

6. The computer-implemented method of claim 4, further comprising:
processing the second code-path with no errors;
flagging the second code-path as error-free; and
updating the code-path map to indicate the second code-path as a preferred code-path.

7. The computer-implemented method of claim 4, further comprising:
recording, at each breakpoint, a set of rewind data, wherein the rewind data captures a state of the application prior to proceeding down a relevant code-path, wherein the set of rewind data is configured to allow the rewinding.

8. The computer-implemented method of claim 4, further comprising:
determining, in response to the rewinding, all code-paths associated with the breakpoint have an identified error; and
rewinding to a next most recent breakpoint.

9. The computer-implemented method of claim 2, wherein the first code-path is newly deployed code, and the second code-path is previously used code.

10. The computer-implemented method of claim 1, further comprising:
logging the first error; and
generating an error report comprising the first error report and any additional identified errors.

11. A system comprising:
a processor; and
a computer-readable storage medium communicatively coupled to the processor and storing program instructions which, when executed by the processor, are configured to cause the processor to:
identify a first error during execution of an application;
determine, in response to the first error, a previous breakpoint in a first code-path of the application prior to the location of the first error;
rewind the application from the first error to the previous breakpoint; and
initiate, in response to the rewinding, a second code-path available at the previous breakpoint.

12. The system of claim 11, wherein the program instructions are further configured to cause the processor to:
analyze the application; and
generate, in response to the analyzing, a code-path map, wherein the identifying the first error is in response to the generating the code-path map.

13. The system of claim 12, wherein each breakpoint is associated with a critical portion of the application.

14. The system of claim 12, wherein the code-path map comprises one or more breakpoints, each breakpoint comprises two or more distinct code-paths configured to obtain a common result.

15. The system of claim 11, wherein the program instructions are further configured to cause the processor to:
process the alternate code-path with no errors;
flag the alternate code-path as error-free; and
update the code-path map to indicate the alternate code-path as a preferred code-path.

16. A computer program product, the computer program product comprising a computer readable storage medium having program instructions embodied therewith, the program instructions executable by a processing unit to cause the processing unit to:
identify a first error during execution of an application;
determine, in response to the first error, a previous breakpoint in a first code-path of the application prior to the location of the first error;
rewind the application from the first error to the previous breakpoint; and
initiate, in response to the rewinding, a second code-path available at the previous breakpoint.

17. The computer program product of claim 16, wherein the program instructions are further configured to cause the processing unit to:
analyze the application; and
generate, in response to the analyzing, a code-path map, wherein the identifying the first error is in response to the generating the code-path map.

18. The computer program product of claim 17, wherein each breakpoint is associated with a critical portion of the application.

19. The computer program product of claim 18, wherein the code-path map comprises one or more breakpoints, each breakpoint comprises two or more distinct code-paths configured to obtain a common result.

20. The computer program product of claim 19, wherein the program instructions are further configured to cause the processing unit to:
process the alternate code-path with no errors;
flag the alternate code-path as error-free; and
update the code-path map to indicate the alternate code-path as a preferred code-path.
